(19) United States
(12) Patent Application Publication
(10) Pub. No.: US 2023/0347301 A1
(43) Pub. Date: Nov. 2, 2023

(54) WATER TREATMENT MEMBRANES EMBEDDED WITH A STABLE AND BACTERICIDAL NANO DIAMOND MATERIAL

(71) Applicants: Francisco Abelardo Colon Nieves, Toa Alta, PR (US); Gerardo Morell, Guaynabo, PR (US); Brad R. Weiner, San Juan, PR (US); Javier Avalos, San Juan, PR (US)

(72) Inventors: Francisco Abelardo Colon Nieves, Toa Alta, PR (US); Gerardo Morell, Guaynabo, PR (US); Brad R. Weiner, San Juan, PR (US); Javier Avalos, San Juan, PR (US)

(21) Appl. No.: 18/302,577

(22) Filed: Apr. 18, 2023

Related U.S. Application Data
(60) Provisional application No. 63/331,923, filed on Apr. 18, 2022.

(51) Int. Cl. B01D 71/02; B01D 69/02; B01D 71/34; B01D 71/68; B01D 53/22; B01D 69/14

(52) U.S. Cl. CPC B01D 69/14111; B01D 53/228; B01D 69/02; B01D 71/021; B01D 71/34; B01D 71/68; B01D 2257/91; B01D 2325/02

(57) ABSTRACT

Nano diamond particles with facile surface functionality and biocompatibility properties are added into membranes used for filtration treatments. FTIR spectra confirm an increase of oxygen functional groups onto the Ultra Dispersed Diamond’s (UDD) surface following acid treatment. SEM images show particle deagglomeration of functionalized UDD at the membrane surface. PES and PDVF membranes express a change in their yield point when UDD is incorporated into the porous matrix. Significant microorganism reduction is obtained and confirmed using t-test analysis at a 95% level of confidence. UDD embedded membranes exhibit a significant bactericidal reduction compared to commercial membranes.

### GOVERNMENT INTEREST

This invention was made with government support under grants 80NSSC19M0049, 80NSSC20M0052 and NNX15AI11H awarded by the National Aeronautics and Space Administration (NASA). The Government has certain rights in this invention.

### BACKGROUND OF THE INVENTION

With the rapidly expanding world population, exploitation of natural resources and extensive pollution, the quality and availability of potable water represent a growing threat to human health (Jackson, R. B. et al., 2001; Ogunlela, O., 2010; Xie, H., Yao, G., & Liu, G., 2015). 2.2 billion people lack access to safely managed drinking water services and 297,000 children under the age of five die every year from diarrheal diseases due to poor sanitation, poor hygiene, or unsafe drinking water (World Health Organization, 2019). The constant expansion of impervious surfaces in urban environments are adding non-point source (NPS) pollutants to the watershed and groundwater catchment areas thereby changing the quality and quantity of available potable water (Sun, Y., Tong, S., & Yang, Y. J., 2016). The recorded deterioration of public health due to waterborne outbreaks caused by this increment of impervious surfaces and improper watershed management in point catchment areas, is an important issue that scientists, public health officials, politicians, and community leaders need to address (Dubinsky, E. A., 2016, Kirschner, A., 2017).

Biocompatible applications of nano materials have been an active research area in recent years because of their unique structure and physicochemical properties. According to previous reports, nano diamonds (NDs) in the size range 2-20 nm are biocompatible with in vitro human cells, (S. Simate et al., 2012; Helland, A., Wick, P., Koehler, A., Schmid, K., & Som, C., 2007; Villalba, P. et al., 2012) and have a large surface area leading to a high affinity for biomolecules (K. Solarska, A. Gajewska, W. Kaczorowski, G. Bartosz, K. Mitura, 2012). Recently, Ultra Dispersed Diamonds (UDD), have gained world-wide attention due to their inexpensive large-scale synthesis based on the detonation of carbon-containing explosives (Market for Nanodiamonds, 2019). These semi-crystalline nanoparticles consist of diamond nanocrystals embedded within a graphite-like carbon matrix forming large aggregates of particulates with some graphitic carbon content (Michel, & Lukehart, C. M., 2015; Ashek-I-Ahmed et al. 2019). The detonation produces UDD with a small primary particle size (ca. 4 -5 nm), high biocompatibility (A. M. Schrand, S. A. Ciftan Hens & O. A. Shenderova, 2009) and the capacity for facile functionalization. Medina et al., (2012), investigated the nano diamond’s surface interaction with P. aeruginosa gram-negative bacteria and concluded that its bactericidal and anti-adhesive properties are due to its semiconducting properties. The electrically active surface causes membrane damage (Etemadi, H., Yegani, R., & Babaeipour, V. 2016) and oxidative stress to the bacteria thereby inducing its death (Medina, O., et. al., 2012). The bactericidal properties and stability of the UDD upon usage and cleaning sparked interest in the nanoparticles for use in water treatment (Yin, J., & Deng, B., 2015; K.K. Upadhyayula, V., Deng, S., Mitchell, M., & B. Smith, G., 2009; Viet Quang, D. et al., 2013).

Membrane separation processes are increasingly utilized methods for the treatment of water and wastewater. Pressure driven membrane technology is a common process for water purification in manufacturing and pharmaceutical industries, who need to meet water quality standards. (Kumar S, 2014). Currently, this methodology confronts key challenges (e.g., membrane selectivity and permeability, and fouling and membrane lifetime), all of which need to be overcome for this technology to become a leading water treatment option. Fouling resistance is one of the biggest challenges for Microfiltration (MF) and Nanofiltration (NF) membranes since most of them are hydrophobic. Functional nanomaterials, incorporated into the membranes may be the solution to these challenges by changing permeability, fouling resistance, as well as their mechanical and thermal stability (Kunduru, K. R. et al., 2017).

Lower membrane fouling allows higher potable water productivity, less cleaning and longer membrane life, leading to reduced capital and operational costs. There are different types of membrane fouling, such as inorganic, organic and biofouling. To reduce fouling, classical solutions are available such as membrane pre-treatment, operation optimization and chemical cleaning (Beyer, F., 2017). Poor and ineffective pre-treatment can lead to higher rates of fouling and all of these treatments have the potential to damage the structural composition of the membrane (Sun, W., Liu, J., Chu, H., Dong, B., 2013). The chemical structure and morphology of the membrane (i.e., functional groups, charge and hydrophobicity, pore size, surface roughness and/or surface pattern) are required knowledge to be able to reduce or increase fouling.

Accordingly, there is a need for new cost-effective membrane materials, capable of overcoming the trade-off between anti-fouling capacity and permeability, as well as simple advanced methods of membrane modification.

### SUMMARY OF THE INVENTION

The present invention enhances current water purification membranes by incorporating nano diamond particles to reduce bio-fouling resistance problems, strengthening their mechanical stability and increasing their useful lifetime for water purification.

According to an aspect of the invention, carbon nanoparticles are embedded in organic and inorganic membranes.

According to another aspect of the invention, the modified membranes are used for microbial removal in filtration treatment.

According to yet another aspect of the invention, the membranes are enhanced by incorporating carbon nanoparticles on their surface.

According to still another aspect of the invention, the enhanced membranes increases the removal of pathogenic microbes leading to enhanced water filtration treatment.

According to an aspect of the invention, the mechanical properties of the membranes embedded with carbon nanoparticles are modified

According to another aspect of the invention, a membrane with higher or lower yield point depending on the membrane’s symmetrical or asymmetrical structure is provided.

According to yet another aspect of the invention, the method of preparing these nanoparticle membranes enhances their useful lifetime and reduces microbial biofouling, thereby increasing drinking water quality and quantity while reducing operational costs for filtration treatment.

### BRIEF DESCRIPTION OF THE DRAWINGS

Further features and advantages of the invention will become apparent from the following detailed description taken in conjunction with the accompanying figures showing illustrative embodiments of the invention, in which:

FIG. 1 shows FITR spectra of Pristine UDD (solid line) and UDD Functionalized (dots line). The results showed typical vibration peaks for UDD and for UDD functionalized peaks characteristics near 3400 cm⁻¹ (—OH stretch), 1700 cm⁻¹ (C═O stretch) and around 1100 cm⁻¹ (C—O—C stretching.

FIG. 2A shows FE-SEM surface porous matrix image of commercial PES.

FIG. 2B shows FE-SEM surface porous matrix image of UDD modified PES.

FIG. 2C shows FE-SEM surface porous matrix image of UDD functionalized PES. UDD PES and UDD functionalized PES membrane images shows UDD particles present both on the membrane’s surface and inside the porous structure of the membrane. The functionalized UDD membrane shows the particles to be more dispersed throughout the membrane and inside its pores.

FIG. 3A shows SEM image for commercial PVDF.

FIG. 3B shows SEM image for UDD PVDF.

FIG. 3C shows SEM image for UDD functionalized PES. SEM images show UDD adhesion to the PVDF membrane around and inside the membrane’s pores.

FIG. 4A is a PES Strain vs. Stress curve for PES UDD composite membrane.

FIG. 4B is a PES Strain vs. Stress curve for UDD Functionalized embedded PES membrane. Compared to commercial PES, sonicated UDD functionalized embedded PES membranes showed a higher yield point values indicating that the NDs can increase the membrane’s stress capacity in the elastic region without changing its original form.

FIG. 5A is a Strain vs. Stress curve for PVDF pristine UDD membranes.

FIG. 5B is a Strain vs. Stress curve for PVDF UDD functionalized membranes.

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

### Methodology

### UDD Antimicrobial Properties

The polluted water source was collected from the Rio Piedras river in San Juan, Puerto Rico (18°24′8.91″N, 66°3′54.44″W), which contains high fecal bacteria concentrations (Lugo, A. E., Ramos Gonzalez, O. M., & Rodriguez Pedraza, C., 2011) mainly caused by anthropogenic outputs, such as household septic tanks and agricultural practices upstream of the river (Garcia-Montiel, D. C., 2014; Laureano-Rosario, A., 2017). A water sample of 750 cm³ was collected and stored in a 1000 cm³ bottle covered in aluminum foil for low light interaction. UDD interaction with the polluted water was obtained by mixing the UDD with 100 mL of the polluted water in a 250 cm³ Erlenmeyer flask. Two 250 cm³ Erlenmeyer flasks, one containing 100 cm³ of polluted water from the river and the other with 100 cm³ of polluted water with UDD were placed in the incubator at 37° C. with a shaker operating at 110 RPM for UDD interaction promotion. Fecal and total coliforms bacteria analyses of the microbial polluted water were done using Coliscan Easygel petri dishes at ten-minute intervals from zero to forty minutes. Bacteria Colony Forming Units (CFU) characterization of the petri dishes was done after 24 hours by using arithmetic sample mean and standard deviation analysis. The calculation of the Coefficient of Variation (CV) was done using sample mean and standard deviation of each time interval. Each microbial characterization was done in triplicate to reduce variability and increase precision.

### UDD Functionalization

UDD usage for biological applications has been limited due to its dispersibility properties caused by particle aggregation in aqueous solutions ranging from 0.1 to 1 micrometer in size (Stehlik, S. et al., 2016 & Whitlow, J., 2017). Recent research has demonstrated that a decrease in the degree of agglomeration is observed when pristine UDD is treated with strong acids (Pedroso-Santana, S., 2017).

UDD powder was obtained from Adamas Nano Inc. The nano diamonds have an average aggregate size of 200 nm, a Z potential of +20 mV in deionized water (DI H₂O) and 1.7 wt% ash content. The nano diamonds were first sonicated with hexane to remove nonpolar impurities, followed by acetone, isopropanol and DI water to remove polar impurities. Each UDD solution was centrifuged after sonication, and the supernatant was removed. Once the UDD was cleaned, the precipitate obtained from the centrifuge was dried using the Labconco FreeZone 2.5 for the lyophilization process.

The lyophilized UDD was treated with a 3:1 Sulfuric Acid (H₂SO₄) (CAS number 7664-93-9)/Hydrogen Peroxide Solution 30% (H₂O₂) CAS number 7722-84-1) solution for surface functionalization and reduce particle’s aggregation. The solution was heated to 120° C. for 30-40 minutes and then cooled to room temperature. The solution was centrifuged to separate the functionalized UDD precipitate. This process was repeated 3 times using Nano pure water and the precipitate was dried using the Labconco FreeZone 2.5 for the lyophilization process.

Characterization of the clean UDD and Functionalized UDD FTIR particles was done by using a Nicolet IS 50 FT-IR Continuum IR Microscope to confirm UDD surface functional groups. The FTIR parameters used were: 32 scans in % Transmittance format with automatic atmospheric suppression. Both powders were placed in a KBr IR card with a 15 mm aperture, which was inserted into the Continuum IR Microscope.

### UDD Membrane Characterization

To investigate the interaction between UDD nanoparticles and commercial membranes, a combination of electron microscopy (JSM-7500F (JEOL, Tokyo, Japan) field-emission scanning electron microscope (FE-SEM) operated at 200 kV), and tensile strength measurements (Brookfield CT3 texture analyzer) were performed to characterize the mechanical properties, i.e. the membrane’s Young Modulus (the stress the membrane can withstand without deforming), yield point (the limit of the material’s elastic region before changing into its plastic region), and the how the elastic and plastic regions of the membrane change upon UDD incorporation. The Young modulus value was obtained by calculating the slope of the elastic region having a R- squared value of 0.9 and the yield point resulted from the elastic region stress increase before moving towards the plastic region. Commercially available membranes, Polyether sulfone (PES) and Polyvinylidene fluoride (PVDF), each one with different surface morphologies and composition, were used. The PES membrane has a symmetric pore size of 0.5 µm with dimensions of 150 µm thickness, and a 47 mm diameter. The PVDF membrane has an asymmetric pore size of 0.45 µm, with dimensions of 125 µm of thickness and a diameter of 47 mm. UDD embedded membranes were fabricated by doing a dead-end filtration of 0.10 wt./vol% UDD solution in125 mL DI water. The formed UDD paste was removed by sonicating the fabricated membrane, and then leaving the material with embedded UDDs at the membrane’s surface and in its porous matrix. 3 membrane samples were obtained, one with the UDD paste, another with 1 minute of sonication for UDD paste removal and the third one with 2 minutes of sonication for UDD paste removal. SEM characterization for all samples was performed to verify the UDD presence at the surface of the membrane.

Sample preparation for the FE-SEM was performed by depositing 10 nm of gold, from a 99.999% Au target, onto the sample using the PELCO SC-7 Auto Sputter Coater. For membrane comparison, we sonicated the UDD embedded membranes for either one or two minutes to remove the UDD excess formed above the membrane. Tensile strength Stress vs. Strain characterization was performed by cutting the studied membrane into 3 × 1 mm rectangles (0.125 mm thick) and placing them in Brookfield cT3 texture analyzer.

### Coliscan Membrane Filtration Characterization

Bacteriological studies between the commercially available membranes and the UDD embedded ones were done using the Micrology Laboratories Coliscan membrane filtration method, a U.S. Environmental Protection Agency approved method for bacteria colony forming units (CFU) enumeration (Taylor, A., 2015). The polluted water source used in this research was collected from the Rio Piedras river in San Juan, Puerto Rico watershed (18°24′8.91″N, 66° 3′54.44″W), which contains high fecal bacteria concentrations (Lugo, A. E., Ramos Gonzalez, O. M., & Rodriguez Pedraza, C., 2011) mainly caused by anthropogenic outputs, such as household septic tanks and agricultural practices upstream of the river (Garcia-Montiel, D. C., 2014; Laureano-Rosario, A., 2017) . The water samples were collected in sterile bottles, stored in an ice cooler and tested within 4 hours of collection. A 1:10 dilution was performed to the collected water using DI water to maintain the CFU enumeration within the limits specified by the Coliscan method. Plate counting was performed and T-test analysis of triplicate samples was done to identify fecal E. coli CFU changes between the membrane filtered samples. The fecal E. coli death rate % comparison between the control and studied membranes was analyzed to see the reduction in CFU counting when the studied water was filtered with UDD embedded membranes.

### Results and Discussion

### UDD Antimicrobial Properties

A study to verify UDD antimicrobial properties was achieved by the treatment of polluted water with different UDD concentrations. Table 1 shows UDD treated water fecal e. Coli CFU and control polluted comparison at different time intervals. Results indicated a significant reduction of CFU when polluted water was mixed with UDD. At zero minutes, the control water and UDD treated water showed fecal E. coli bacteria concentration of 950±100 Col/cm³ and 875±98 Col/cm³, respectively. After forty minutes, control plates had a sample mean of 2,425±96 Col/cm³ and UDD treated water plates had a sample mean of 150±57 Col/cm³. Fecal coliforms death rate results for each time interval showed a constant reduction of CFU as time passed.

TABLE 1

Fecal e. coli CFU and coefficient of variation % for polluted water and UDD treated water with UDD petri dish samples

| UDD (g/cm³) | Time (Min.) | Sample Mean Untreated H₂O (Col/cm³) | C.V. % | Sample Mean UDD Treated H₂O (Col/cm³) | C.V. % | Death Rate % |
|---|---|---|---|---|---|---|
| 0.01 | 0 | 950±100 | 1 | 875±96 | 11 | 7 |
| | 10 | 1225±126 | 10 | 525±95 | 18 | 58 |
| | 20 | 1750±129 | 7 | 500±58 | 11 | 71 |
| | 30 | 2175±170 | 8 | 275±50 | 18 | 87 |
| | 40 | 2425±96 | 4 | 150±57 | 38 | 94 |
| 0.02 | 0 | 600±0 | 0 | 300±100 | 33 | 50 |
| | 10 | 733±208 | 28 | 233±58 | 50 | 68 |
| | 20 | 833±153 | 18 | 200±100 | 50 | 76 |
| | 30 | 1000±100 | 10 | 133±58 | 43 | 87 |
| | 40 | 1166±58 | 5 | 33 ${\pm }_{0}^{58}$ | 117 | 97 |

In order to increase the fecal E. coli death rate, we increased the UDD concentration to 0.02 g/cm³ and the results were similar. The CV % shown in Table 1 for 0.02 g/cm³ UDD suggests a higher variability in UDD treated plates in comparison to untreated water as time passes. This high variability is likely due to a decrease of UDD treated water Col/cm³. When the mean value approaches to zero, the coefficient of variation will approach infinity and is therefore sensitive to small changes in the mean. A 97% death rate was achieved compared to the 94% at 0.01 g/cm³ UDD concentration. These results demonstrate UDD’s bactericidal properties suggesting the use of these nanoparticles as disinfectant agent for water microbial treatment.

### UDD Particle Characterization

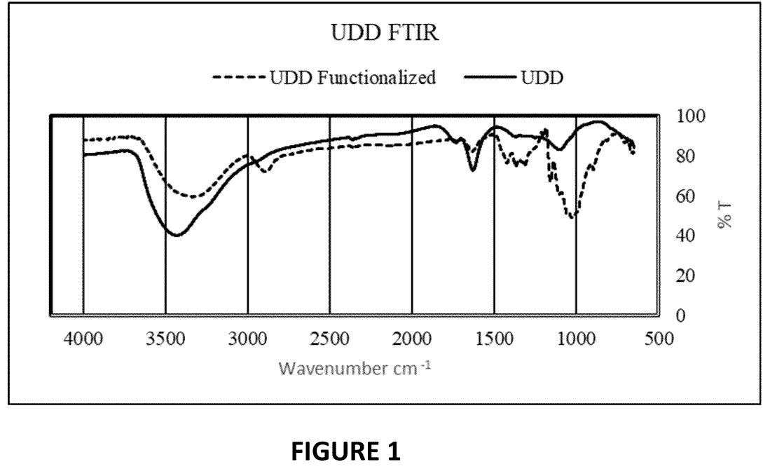

FIG. 1 shows the FTIR spectra for commercial and functionalized UDD nanoparticles. For both the commercial and functionalized UDD FTIR spectra, the broad feature near 3400 cm⁻¹ was assigned to the H-O stretching vibration Previous reports have found that UDD adsorbs atmospheric water soon after the sample precipitate is exposed to air (Ji, S., Jiang, T., Xu, K., & Li, S., 1998). Both spectra also showed the C-H stretching at 2900 cm ⁻¹ and H-O-H bending vibration feature at 1600 cm⁻¹ (Bradac, C. et al., 2018). Compared to commercial UDD, UDD functionalized spectra showed a more pronounced broad absorption band in the region 1000-1500 cm⁻¹, known as the UDD fingerprint area. This spectral region is correlated to the stretching vibration of C-C and C-O-C (Vatanpour, V., 2018). The absorption band around 1100 cm⁻¹ is characteristic of stretching vibrations of C-O-C of ether and/or ester functional groups (Dworak, N., Wnuk, M., Zebrowski, J., Bartosz, G., & Lewinska, A., 2014). This peak intensity change in the UDD functionalized surface composition is consistent with the insertion of oxygen functional groups following the acid treatment (Huang, H., Wang, Y., Zang, J., & Bian, L., 2012; Wang, T. et al., 2017). As a result, the UDD surfaces are polar and more hydrophilic.

### Membrane SEM Images

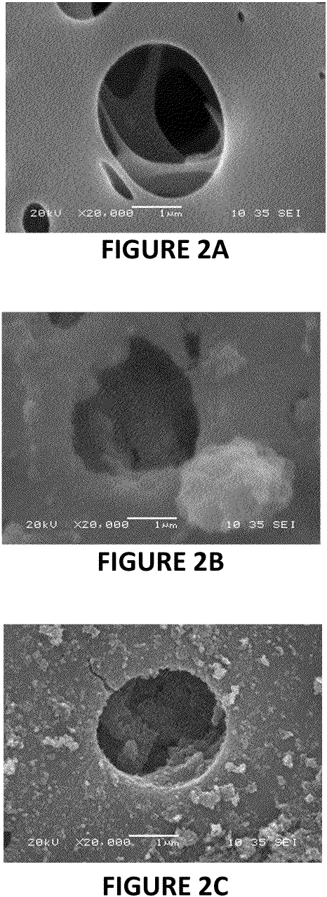

SEM characterization was performed on commercial and modified membranes to understand the nature of the surface following UDD incorporation. FIGS. 2A-2C present the PES FE-SEM images at 20,000X magnification for surface analysis. FIG. 2A shows the PES’s symmetric porous matrix prior to the addition of the UDD solution. When UDDs were added, a cluster formation can be seen imbedded in the porous matrix (FIG. 2B). These UDD clusters have different sizes, ranging from a 0.1-10 microns, and are most likely caused by the coupling of C-C bonds between nanoparticles (Popov, 2021), van Der Waals forces and electrostatic interactions (Wahab, Z., Foley, E. A., Pellechia, P. J., Anneaux, B. L., & Ploehn, H. J., 2015; Zheng, W.-W. et al., 2009). Different from FIG. 2B, the embedded functionalized UDDs (FIG. 2C) form smaller clusters within the porous matrix. The UDD amount embedded on PES membranes changes when sonication is done to remove the nanoparticles’ excess above the membrane’s surface. Table 2 shows how Wt. % of UDD embedded in the membrane is significantly reduced after 1 minute and two minutes of sonication. For UDD PES and UDD Funct. membranes, Wt.% are 51% and 62 % compared to 8.0% and 2.9 % respectively after sonication is performed for 1 minute to remove UDD excess above the membrane.

TABLE 2

Wt. % of UDD embedded on PES Membrane

| Membrane | Weight (g) | UDD Wt. % |
|---|---|---|
| PES | 0.0696±0.0001 | 0 |
| UDD PES | 0.1048±0.0140 | 51 |
| UDD PES Funct. | 0.1127±0.0013 | 62 |
| UDD PES 1 min. | 0.0751±0.0073 | 8.0 |
| UDD PES 2 min. | 0.0788±0.0062 | 13 |
| UDD PES Funct. 1 min. | 0.0716±0.0004 | 2.9 |
| UDD PES Funct. 2 min. | 0.0712±0.0001 | 2.4 |

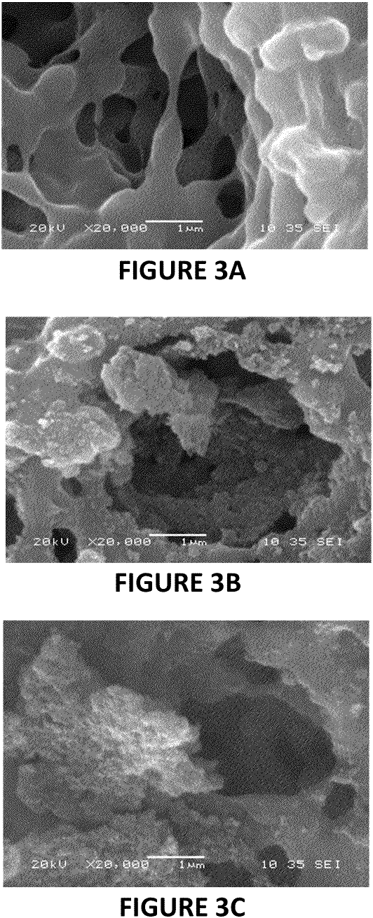

Similar to PES membranes, PVDF SEM images show UDD nanoparticles embedded at the membrane’s surface. The asymmetric porous matrix of PVDF (FIG. 3A) is covered by UDD nanoparticles when the dead-end filtration technique is performed and the UDDs are embedded (FIGS. 3B and 3C). The cluster size decrease shown in FIGS. 2C and 3C suggests that the acid treatment not only increases the oxygen-containing functional groups present in the UDDs, but also deagglomerates the nano diamond (Astuti, Y., 2017) causing these nanoparticles to be more dispersed throughout the membrane surface and inside the porous matrix (Yu, Q., Kim, Y. J., & Ma, H., 2006; Xu, K., & Xue, Q., 2007; Ushizawa, K. et al., 2002).

The PVDF membrane’s structure also plays a role when UDDs are embedded into its porous matrix (Table 3). UDD Wt.% on UDD Funct. PVDF membranes are 27% less compared to UDD PVDF. UDD deagglomeration of clusters and the asymmetric structure of PVDF compared to the symmetric PES can be a possible reason for the UDDs to pass through the porous matrix and not be embedded above the surface.

TABLE 3

Wt. % of UDD embedded on PES Membrane

| Membrane | Weight (g) | UDD Wt.% |
|---|---|---|
| PVDF | 0.1205±0.0002 | 0 |
| UDD PVDF | 0.1739±0.0092 | 44 |
| UDD PVDF Funct. | 0.1413±0.0084 | 17 |
| UDD PVDF 1 min. | 0.1472±0.0064 | 13 |
| UDD PVDF 2 min. | 0.1393±0.0021 | 16 |
| UDD PVDF Funct. 1 min. | 0.1426±0.0034 | 14 |
| UDD PVDF Funct. 2 min. | 0.1430±0.0010 | 15 |

From an operational point of view, the leaching of biocompatible nanoparticles i.e. UDD, may be part of the sieving effect phenomena during the membrane filtration process (Drioli, E., Giorno, L., &amp; Fontananova, E., 2017). The particles larger than the pore size are retained, and the smaller size nanoparticles are leached into the effluent water.

### Membrane Tensile Strength

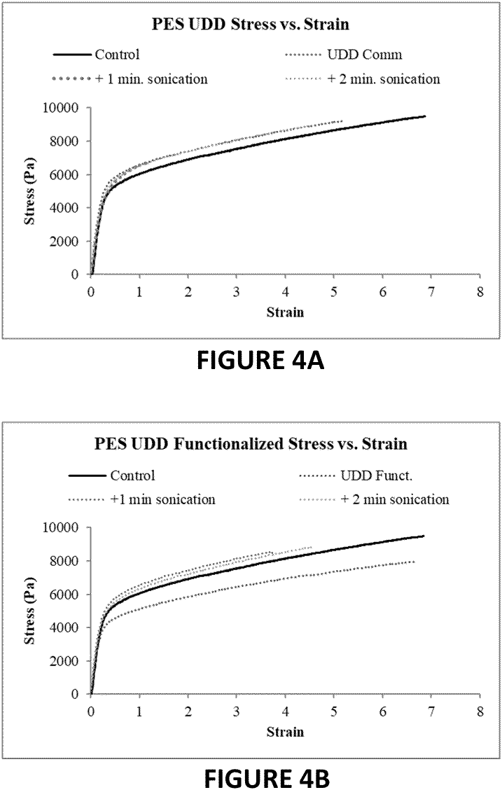

The membrane tensile strength characterization was performed using the STAM-D, SANTAM instrument to measure a Strain vs. Stress curve to determine Young Modulus and yield point values when UDDs were embedded into its porous matrix. FIGS. 4A and 4B present the PES UDD tensile strength curves between the pristine UDD and functionalized UDD embedded membranes. FIG. 4A shows how the elastic region’s yield point increases when the UDD are embedded to the membrane surface and porous matrix. When Functionalized UDDs are inserted in the membranes (FIG. 4B) it also increases the membranes yield point but, after the UDD paste is removed by sonicating the membrane.

TABLE 4

Young Modulus value comparison between the pristine UDD and functionalized UDD embedded PES membranes

| Young Modulus (Pa) | PES | PES UDD | PES UDD + 1 min. Sonication | PES UDD + 2 min. Sonication |
|---|---|---|---|---|
| $E = \frac{σ}{∈}$ | 20878 | 21271 | 20120 | 20505 |
| Young Modulus (Pa) | PES | PES UDD Funct. | PES UDD Funct. + 1 min. Sonication | PES UDD Funct. +2 min. Sonication |
| $E = \frac{σ}{∈}$ | 20878 | 21421 | 20795 | 19192 |

The PES membrane’s ability to withstand stress without deforming between commercial PES (control) and UDD embedded PES samples is shown in the Young Modulus (Table 4.) values. The results show that PES’ ability to withstand stress does not significantly change when UDD nanoparticles are embedded into the membrane’s porous matrix. These findings suggest that the incorporation of UDD into the porous matrix does not change the membrane’s ability to withstand stress but does increase its yield point in the elastic region, enhancing its ability to support higher stress before deformation.

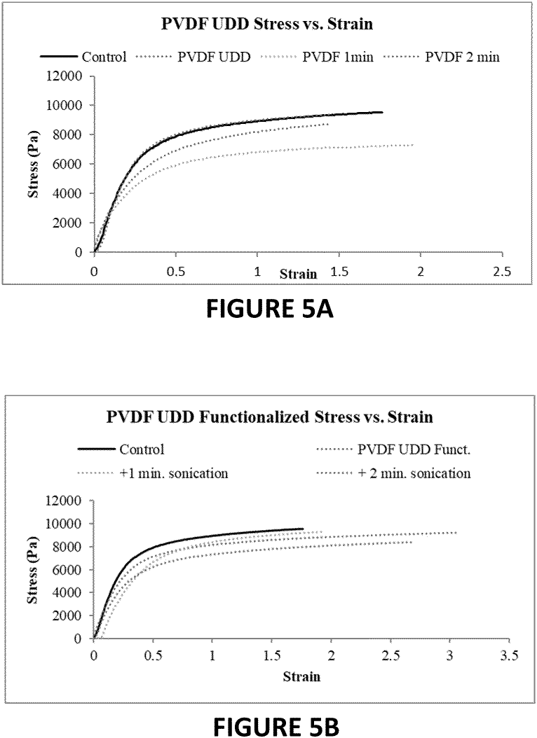

For PVDF membranes, a different result was seen compared to PES. FIGS. 5A and 5B shows the Strain vs. Stress curve for PVDF (control) and UDD embedded PVDF membranes and Table 5 the membranes Young Modulus. UDD embedded membranes showed a decrease in yield point and Young Modulus values compared to commercial PVDF. The decrease in these properties (i.e., the membrane’s ability to withstand stress without deforming in the elastic region) may be due to the UDDs dispersion throughout the asymmetrical porous surface (Yuan, X., 2020). These changes in the membranes’ plastic and elastic regions are consistent with the findings reported in literature on how the incorporation of NDs change the membrane’s mechanical properties (Zhai, Y.J. et al., 2011; Bedar, A. et al., 2020; Bedar, A., Tewari, P. K., Bindal, R. C., & Kar, S., 2020).

TABLE 5

Young Modulus value comparison between the pristine UDD and functionalized UDD embedded PVDF membranes

| Young Modulus (Pa) | PVDF | PVDF UDD | PVDF UDD + 1 min. Sonication | PVDF UDD + 2 min. Sonication |
|---|---|---|---|---|
| $E = \frac{σ}{∈}$ | 27705 | 29755 | 21381 | 23940 |
| Young Modulus (Pa) | PVDF | PVDF UDD Funct. | PVDF UDD Funct. + 1 min. Sonication | PES UDD Funct. + 2 min. Sonication |
| $\text{E} = \frac{σ}{∈}$ | 27705 | 21163 | 23573 | 21503 |

### Coliscan Membrane Filtration Characterization

Bactericidal properties of studied membranes are detailed in Tables 6 and 8 showing the CFU death rate % comparison between the commercial and UDD embedded membranes. When microbially polluted water was filtered by the UDD embedded PES membrane, the filtered water showed a death rate of 89% compared to the 88% shown by commercially available PES membrane. At a 5% confidence interval, T-test analysis between the UDD Embedded PES and the commercial PES indicates no significant reduction on fecal E. coli CFU after the filtration was performed. Different to this, a significant difference in bacteria removal was seen, with a value of 0.02, between the functionalized UDD embedded PES membrane and commercial PES indicating that the excess particle clusters above the membrane does not improve bactericidal properties and can lead to poor bacteria removal.

Like the previous analysis, UDD embedded PES membranes that were sonicated to remove the excess of particle clusters above the membrane also showed that there is no significant difference when the water was filtered. Table 6 also shows the death rate % values when the water was filtered with sonicated funct. UDD embedded PES membranes. Contrary to previous results, sonicating the UDD functionalized membranes, enhances its bactericidal properties by significantly reducing fecal e. Coli CFU as compared to commercial PES membranes. The incorporation of these nanoparticles into the membrane’s porous matrix increases the bacterial death rate percentage by 5% to 8% depending on the sonication time for UDD cluster removal. T-test analysis of CFU values dependent on sonication time showed a p-value of 0.20 (Table 7) between PES UDD Funct. 1 min. and PES UDD Funct. 2 min. meaning that there is no significant difference of bacterial removal if the membrane is sonicated for 1 or 2 two minutes.

TABLE 6

Fecal e. Coli CFU and % rate percentage of UDD PES membrane filtration characterization

| | Control | PES Membrane | UDD/PES Membrane | UDD/PES Membrane 1 min. Sonication | UDD/PES Membrane 2 min. Sonication | UDD funct./PES Membrane | UDD funct./PES Membrane 1 min. Sonication | UDD funct./PES Membrane 2 min. Sonication |
|---|---|---|---|---|---|---|---|---|
| Colony Forming Units (CFU) | 12000 | 1493 | 1360 | 1107 | 1080 | 2533 | 800 | 480 |
| ± | 0 | 23 | 302 | 220 | 396 | 231 | 57 | 170 |
| Death Rate % | 0 | 88 | 89 | 91 | 91 | 79 | 93 | 96 |

TABLE 7

T-test analysis of sonication time on PES UDD embedded membranes.

| T.Test | p-value at 95% significance |
|---|---|
| PES UDD 1 min. & PES UDD 2 min. | 0.94 |
| PES UDD Funct. 1 min. & PES UDD Funct. 2 min. | 0.20 |

For PVDF membranes, Table 8 shows the CFU values of UDD embedded PVDF membranes filtered water. Compared to the control sample, commercial and studied UDD PVDF membranes significantly reduce bacteria concentration with a death rate of 80% and 83% respectively. T-test analysis from these two filtrations gave the value of 0.26 suggesting no significant difference. For UDD functionalized membrane comparison, a result of 0.0003 demonstrated that the incorporation of functionalized membranes into the PVDF porous matrix significantly reduces bacteria concentration compared to commercial ones. The insertion of a more dispersed UDD significantly improves PVDF bactericidal properties by reducing CFU by 17 % more producing water with minimum bacteria CFU.

TABLE 8

Fecal e. Coli CFU and % rate percentage of UDD PVDF membrane filtration characterization

| | Control | PVDF Membrane | UDD/PVDF Membrane | UDD embedded PVDF Membrane 1 min. sonication | UDD/PVDF Membrane 2 min. sonication | UDD Funct./PVDF Membrane | UDD Funct./PVDF Membrane 1 min. Sonication | UDD Funct./PVDF Membrane 2 min. sonication |
|---|---|---|---|---|---|---|---|---|
| Colony Forming Units (CFU) | 12000 | 2400 | 2000 | 1173 | 780 | 333 | 260 | 547 |
| ± | 0 | 139 | 283 | 335 | 255 | 61 | 85 | 220 |
| Death Rate % | 0 | 80 | 83 | 90 | 94 | 97 | 98 | 95 |

TABLE 9

T-test analysis of sonication time on PVDF UDD embedded membranes.

| T.test | p=value at 95% significance |
|---|---|
| PVDF UDD 1 min. & PES PVDF 2 min. | 0.24 |
| PVDF UDD Funct. 1 min. & PVDF UDD Funct. 2 min. | 0.14 |

T-test analysis of CFU values dependent on sonication time showed a p-value of 0.14 (Table 9) between PVDF UDD Funct. 1 min. and PVDF UDD Funct. 2 min. meaning that there is no significant difference of bacterial removal if the membrane is sonicated for 1 or 2 two minutes. These improvements of both membranes’ bactericidal properties are consistent with the ones reported in the literature when this the incorporation of carbon nanoparticles into organic membranes are done (Etemadi, H., Yegani, R., & Babaeipour, V., 2016).

### Conclusions

The present invention provides the use of UDD as a new disinfection material for water treatment. The results show that UDD effectively reduces fecal e. Coli bacteria CFU concentration in polluted surface water. A death rate between 94% and 97% was observed in UDD treated water plates depending on UDD concentration.

UDD FTIR spectra from functionalized UDD showed prominent peaks at the UDDs characteristic region (from 1000 cm⁻¹ to 1500 cm⁻¹) compared to commercial UDD, indicating the addition of oxygen containing functional groups into the UDDs surface. SEM images of PES and PVDF membranes showed UDD particles at the membranes’ surface and symmetric (PES) and asymmetric (PVDF) porous matrix. Compared to commercial UDD, functionalized UDD looked more spread throughout the membrane surface and UDD cluster sizes were smaller. The the increase in Oxygen-containing functional groups shown by the FTIR spectra promotes UDDs deagglomeration and enhances UDDs hydrophilic properties causing these nanoparticles to be more dispersed throughout the membrane surface and inside the porous matrix.

Tensile Strength characterization for PES membranes demonstrated no change in its Young Modulus values and an increase in the membranes’ yield point when UDDs were embedded. A higher yield point was observed when UDD nanoparticles are embedded into the porous matrix and the membrane is sonicated to remove the excess of nanoparticles at the top of the surface. A decrease of tensile strength yield point was detected in UDD embedded PES membranes that contained a high concentration of UDDs at the porous matrix. For PVDF membranes, a different result was seen compared to PES. UDDs dispersion throughout its asymmetrical porous matrix makes the membranes less elastic, reducing its yield point and Young Modulus values. The changes in the membranes’ plastic and elastic regions tailor towards into the findings reported in literature on how the incorporations of NDs changes the membranes mechanical.

Coliscan Membrane Filtration characterization were performed for commercial and UDD embedded membranes. The insertion of functionalized UDDs into the PES and PVDF commercial membranes significantly enhances bacteria removal by 5% to 8%, for PES, and 17% for PVDF, providing a better water quality, enhancing its current bactericidal properties demonstrating these membranes enhance current water filtration technology for bacteria removal properties.

The development of these organic/Carbon nanoparticle membranes has the potential to enhance current membrane lifetime usage by changing the membrane’s plastic and elastic properties, enhancing microbial removal properties thereby having the potential to produce better drinking water quality and quantity for membrane filtration treatment systems.

Although the present invention has been described herein with reference to the foregoing exemplary embodiment, this embodiment does not serve to limit the scope of the present invention. According to a preferred embodiment, Ultra Dispersed Diamond (UDD) nanoparticles are used to enhance the membranes according to the invention. However, one of ordinary skill in the art would understand that alternatively, other nanodiamond particles can be used including but not limited to: graphene, graphene quantum dots, carbon nanoparticles, carbon quantum dots, and other variants of carbon nanoparticles as long as the carbon allotropes share the same biocompatibility, large surface area and electrical conductivity properties previously explained for the UDD nanoparticles. In addition, Polyether sulfone (PES) and Polyvinylidene fluoride (PVDF) organic filtering membranes are used according to a preferred embodiment of the invention. However, one of ordinary skill in the art would understand that the invention can be implemented with other organic polymeric membranes such as but not limited to polysulfone, cellulose acetate, polymethylpentene, polyimide, polyetherimide, polycarbonate, polydimethylsiloxane, and polyphenyleneoxide. as well as inorganic membranes (i.e., containing metals, oxides, or elementary carbon in their structure) such as but not limited to carbon molecular sieves, nanoporous carbon, mixed conducting perovskites, zeolites, amorphous silica, and palladium alloys, as long as these membranes provide the necessary electron exchange between the functional groups located at the membranes’ porous matrix and its surface with the nanoparticles functional groups which is mainly caused by the electron affinity. Furthermore, according to a preferred embodiment of the invention, the membranes are used to filter contaminants and undesired particles from water. However, the invention can be used to filter other types of fluids such as, but not limited to gases, such as oxygen, and other liquids. This is due to the nanoparticle embedded membrane’s electron affinity to the fluids. Essentially, the electron exchange between the contaminant molecule’s functional groups and the nanoparticles’ functional groups makes these molecules attached to the nanoparticles decreasing the concentration of contaminant molecule in the fluids. Also, while the present invention uses a Piranha Reaction acid treatment [3:1 Sulfuric Acid (H2SO4) and Hydrogen Peroxide Solution 30% (H2O2)], to eliminate organic traces and residues present in the nanoparticles, other alternatives to this acid treatment can be used such as but not limited to such as potassium hydroxide/ethanol bath and NOCHROMIX™, as long as the reaction reduces organic residues from the nanoparticles. Accordingly, those skilled in the art to which the present invention pertains will appreciate that various modifications are possible, without departing from the technical spirit of the present invention.

1. A contaminant filtering membrane comprising:
a filtering membrane embedded with carbon nanoparticles.

2. The contaminant filtering membrane of claim 1, wherein said carbon nanoparticles comprise one of detonation diamond, ultra-dispersed diamond (UDD), graphene, graphene quantum dots, carbon nanoparticles, or carbon quantum dots.

3. The contaminant filtering membrane of claim 1, wherein said carbon nanparticles are functionalized with Sulfuric Acid (H₂SO₄) and Hydrogen Peroxide Solution 30% (H₂O₂).

4. The contaminant filtering membrane of claim 3, wherein said Sulfuric Acid (H₂SO₄) and said Hydrogen Peroxide Solution 30% (H₂O₂) are provided in a 3:1 proportion, respectively.

5. The contaminant filtering membrane of claim 1, wherein said filtering membrane is an organic membrane.

6. The contaminant filtering membrane of claim 1, wherein said filtering membrane is an inorganic membrane.

7. The contaminant filtering membrane of claim 5, wherein said organic membrane comprises one of Polyether sulfone (PES), Polyvinylidene fluoride (PVDF), polysulfone, cellulose acetate, polymethylpentene, polyimide, polyetherimide, polycarbonate, polydimethylsiloxane, or polyphenyleneoxide.

8. The contaminant filtering membrane of claim 6, wherein said inorganic membrane comprises one of carbon molecular sieves, nanoporous carbon, mixed conducting perovskites, zeolites, amorphous silica, or palladium alloys.

9. The contaminant filtering membrane of claim 1, wherein said contaminant filtering membrane is used to filter contaminants from a liquid.

10. The contaminant filtering membrane of claim 1, wherein said contaminant filtering membrane is used to filter contaminants from a gas.

11. The contaminant filtering membrane of claim 9, wherein said liquid is water.

12. The contaminant filtering membrane of claim 10, wherein said gas is oxygen.

13. The contaminant filtering membrane of claim 1, wherein said filtering membranes comprise porous polymers.

14. The contaminant filtering membrane of claim 13, wherein a porosity of said porous polymers ranges from 0.1 to 1.0 micrometres.

15. The contaminant filtering membrane of claim 1, wherein said carbon nanoparticles have a size ranging from 1 to 100 nanometres.

16. The contaminant filtering membrane of claim 1, wherein said carbon nanoparticles are clustered or dispersed on said filtering membrane.

17. The contaminant filtering membrane of claim 1, wherein said contaminant filtering membrane is effective against at least one of pathogenic bacteria, non-pathogenic bacteria, pathogenic virus, or non-pathogenic virus.

18. The contaminant filtering membrane of claim 17, wherein said bacteria and virus comprise fecal coliforms or airborne bacteria.

19. The contaminant filtering membrane of claim 1, wherein said contaminant filtering membrane has a bactericidal effectiveness ranging from 80-100%.
